(19) United States
(12) Patent Application Publication
(10) Pub. No.: US 2023/0291549 A1
(43) Pub. Date: Sep. 14, 2023

(54) SECURELY SHARING SECRET INFORMATION THROUGH AN UNSECURE CHANNEL

(71) Applicant: VMware, Inc., Palo Alto, CA (US)

(72) Inventors: Lyubomir Vlahov, Sofia (BG); Georgi Muleshkov, Sofia (BG); Hristo Dimitrov, Sofia (BG)

(21) Appl. No.: 17/694,607

(22) Filed: Mar. 14, 2022

(51) Int. Cl. H04L 9/08

(52) U.S. Cl. CPC H04L 9/0825; H04L 9/0869; H04L 9/0894

(57) ABSTRACT

Secure exchange of information over an unauthenticated communication channel between a sender and a receiver can be implemented as computer-implemented methods, media, and systems. In response to receiving an identifier (ID) of the receiver, a sender provides a symmetric key to the receiver that matches the ID. The symmetric key is configured for use by the receiver to decrypt encrypted information provided by the sender. The sender receives a plurality of heartbeat calls from a receiver to notify the sender of availability to receive encrypted information. Each call of the plurality of heartbeat calls includes a checksum of the symmetric key. In response to determining that the received plurality of heartbeat calls comply with one or more verification rules for confirming an identity of the receiver, the sender sends the encrypted information for decryption by the receiver using the symmetric key.

### BACKGROUND

This specification relates to sharing confidential data between applications.

Software applications can provide services and access to resources. In some cases, resources may be restricted to a limited number of users or entities based on authorization rules. For example, different access rights may be associated with different applications, users and/or user roles. In some cases, communication between applications can be performed over unsecure channels that do not require authentication.

### SUMMARY

This specification describes technologies relating to secure sharing of information over unsecured communication channels between a sender and a receiver, for example, between a first application and a second application.

Particular embodiments of the subject matter described in this specification can be implemented so as to realize one or more of the following advantages.

Using techniques described in this specification, sharing of secret data (e.g., sensitive confidential data) between applications can be managed more reliably and securely. The receiver is configured to send heartbeat calls to the sender to provide status notices for possessing or not possessing a symmetric key that can be used for decrypting secret data encrypted with same symmetric key. The sharing of secret data can be based on encryption and decryption according to the prior exchanged symmetric key. The sender of secret data can implement one or more verification rules to determine whether a requestor for secret data is in possession of the right symmetric key and whether the requestor is the true target receiver for that secret data. The sender can be implemented with logic to evaluate received heartbeat calls from the receiver to determine whether to confirm or reject the identity as claimed by a receiver and to proceed (or not) with sharing the secret data. Thus, the sender's identity verification supports a more efficient yet reliable method to determine whether to share or deny sharing of secret data based on a particular symmetric key. Further, the implemented logic for verification at the sender supports improved accuracy in the determination whether a requestor for secret data is a genuine receiver or an imposter.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an a schematic diagram illustrating an example computing environment where two applications exchange secret data over an unsecured communication channel using symmetric key identity verification in accordance with some embodiments.

FIG. 2 is a flowchart of an example process for sharing data in secure manner over an unsecured communication channel in accordance with some embodiments.

FIG. 3 is a schematic diagram illustrating an example for exchanging a symmetric key that is used for subsequent encryption and decryption of exchanged information from a sender to a receiver application in accordance with some embodiments.

FIG. 4 is a schematic diagram illustrating an example for denying sharing of secret information from a sender in response to determining inconsistency and failure to verify identity of a receiver as a target receiver for the secret information in accordance with some embodiments.

Like reference numbers and designations in the various drawings indicate like elements.

### DETAILED DESCRIPTION

This specification describes techniques for securely sharing sensitive secret data over unsecure communication channels.

In some embodiments, two applications communicate over an unsecure communication channel that does not include identity authentication. The communication between the applications can be performed by exchanging requests that are identified by application identifiers (IDs) (e.g., unique IDs). In some instances, the applications may share secret information (e.g., sensitive information such as credential data) over a unsecure communication channel. However, since the applications do not authenticate during exchange of data over an unsecure communication channel, sharing of sensitive data can be associated with higher risks of data breaches and thefts.

For example, the two applications are a software platform and an application that has been registered with the software platform. The software platform registers the application (e.g., based on a registration requests from the application) and provides the application with an application ID for use when interacting with the software platform. In some of those examples, once the application is registered at the software platform, the software platform implements scenarios that require sharing of sensitive information (e.g., credential data) with the application over an unsecure communication channel.

In some embodiments, when a sending application (e.g., a platform or other sending application/service) shares secret data with another target receiving application, the sending application possesses identity information of the receiving application. For example, such identifying information of the receiving application can include the application ID of the receiving application as pre-registered at the sending application, or another ID that can uniquely distinguish receivers of secret data shared by the sending application. An identifier of the receiving application can include a unique ID that is only known to the two applications involved in the sharing of the secret information. However, in case the ID of the receiving application is obtained by a third party, such third party may attempt to impersonate the receiving application and obtain access to secret information that is designated to the receiving application by the sending application. Therefore, in some embodiments, sharing of secret information is performed by encrypting the secret information using a symmetric key encryption. The symmetric key can be used for both encryption and decryption of the secret information.

In some embodiments, the symmetric key is provided by the sending application to the receiving application prior to sharing the secret information. The sending application shares the secret information once the sender application can verify the identity of an entity requesting access to the secret information. In some embodiments, the sending application is configured to evaluate received heartbeat calls from the receiving application according to one or more verification rules. The sending application uses the one or more verification rules to confirm that the entity that sends the heartbeat calls corresponds to the target receiver for the secret data that has obtained (and also potentially imported) the symmetric key.

In some embodiments, when the sending application provides the secret information in encrypted form to the receiving application, the receiving application decrypts the encrypted secret information and accesses the secret.

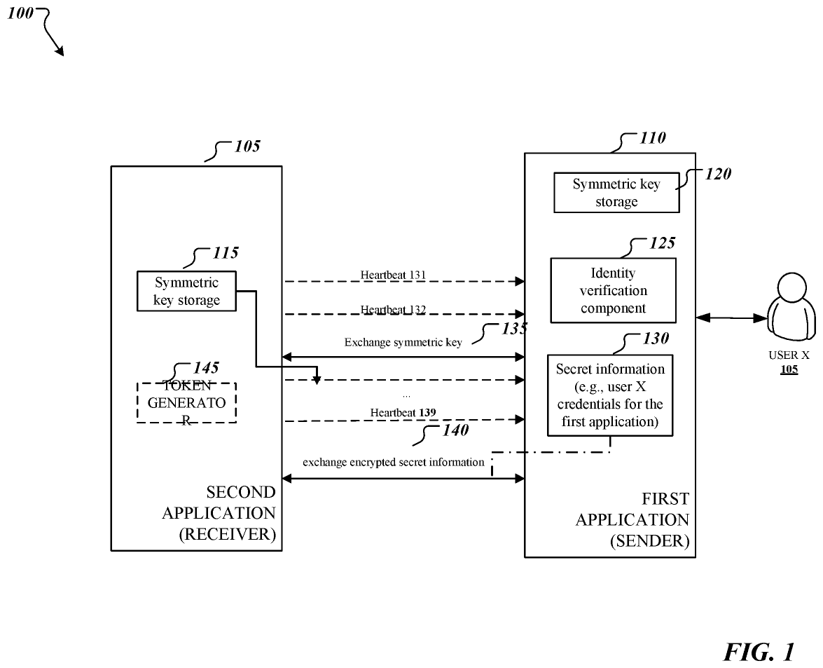

FIG. 1 is a schematic diagram illustrating an example computing environment 100 where two applications exchange secret data over an unsecured communication channel using symmetric key identity verification in accordance with some embodiments.

In some implementations, the two applications communicate and exchange data including privacy protected data that requires secure sharing. For example, the first application can be a computing platform that provides services to a second application that is registered at the platform.

In some instances, a first application 110 is a sender application that receives user interaction from a user 105 and performs operations according to implemented logic. In some cases, the first application 110 stores (or has access to) secret information, such as secret information 130, that is shared with a second application 105 (a receiver). The first application 110 wants to share the secret information 130 to the second application while the sharing is data privacy protected. In some instances, the sharing of data between the two applications can be achieved over a secure or over an unsecure communication channel.

In some embodiments, the established communication channel between the first application 110 and the second application 105 is an unsecure communication channel and when sensitive data is to be shared over such data, data privacy protection measures can be implemented to ensure secure data exchange.

In some implementations, the second application 105 is registered at the first application 110 and thus, the first application 110 identifies the second application 105 for example based on an application ID or other secret ID that can be used to uniquely identify different applications registered at the first application 110. In some instances, multiple applications including the second application 105 are registered at the first application 110 and request data sharing (e.g., secret data sharing) that is to be used by different implemented scenarios at the registered applications.

In some implementations, the second application 105 is configured to send regular heartbeat calls (e.g., heart beat call 131, 132, up to 139) to the first application 110 to provide notification status of the second application 105. The heartbeat calls may include identification of the second application such as the application ID of the second application 105. The first application 110 can recognize origin of calls based on the provided application ID. In some cases, this application ID is a secret ID that is configured to be known to the first and second application only and can be shared on a need-to-know-bases. The sending of heartbeat calls from the second application 105 to the first application 110 can be used to determine the status of the second application 105 and to be used to verify the identity of the second application 105.

For example, if an imposter steals the application ID of the second application 105 and attempts to present themselves as the second application 105, the imposter may use the stolen application ID of the second application 105 and send requests to the first application 110. However, if the first application 110 monitors received calls from applications including the second application 105, the first application 110 will recognize that two entities are presenting themselves as the second application based on a single application ID. In some instances, such recognition of inconsistencies between calls received from an alleged second application can be based on evaluation of received heartbeats. If two application are sending sequentially or in parallel heartbeats with the same application identifier, the received heartbeats would not correspond to the same regime of notification. Further, if any data is exchanged with a receiver—either the second application 105 or an imposter—both receiving parties would be able to provide different responsive notifications since they both have access to different data.

For example, one of the applications would have received shared information from the first application, however, the second one (the application that has a subsequent call for obtaining the data) would notify that has no possession of such data. In some instances, the first application 110 evaluates heartbeat calls received after the first application 110 has been notified that a provided symmetric key has been imported in the receiver. The notification with the confirmation of the successful import event can be used as a start event for triggering evaluation of subsequent heartbeat calls notifying about the status of the alleged receiver (e.g., without evaluating calls that request symmetric keys that have already been provider to a particular receiver). In some instances, contradicting statements related to knowledge of events or shared data between the first application and a receiver can be recognized when two instances are identifying the same instance. In those cases, the first application 110 determined that neither of the entities that present themselves as the second application can be trusted to correspond to the second application 105. In some instances, if the first application 110 determined that there are potentially more than one receiving parties that present themselves as the second application 105, the first application 110 may deny sharing of information with both entities.

In some implementations, when the first application 110 wants to share secret information 130 to the second application 105, the first application 110 can provide a symmetric key (at 135) to the second application 105 that is to be used for encrypting and decrypting the secret information 130 and to support secure data exchange. In some instances, the first application 110 generates the symmetric key, for example, based on a random generation method or other key generation scheme. The first application 110 stores the symmetric key in a symmetric key storage 120 and maps an application ID to the symmetric key to identify a target receiver of the secret information based on such symmetric key encryption. The symmetric key storage 120 can include data associated with the exchange of the symmetric key such as time of sharing, time of acknowledgement of successful receiving of the shared symmetric key (e.g., confirmation of a successful import operation of the symmetric key at the receiver 105), status for the use of the key (e.g., locked when the symmetric key has been shared once with a receiving party, available when the symmetric key is generated and not yet shared with the receiving party, others). When the second application 105 receives the symmetric key, the second application 105 stores it into a symmetric key storage. In some instances, the second application 105 sends heartbeat calls to the first application that may overlap the period of the symmetric key exchange at 135, and subsequent heartbeats sent from the second application 105 can include information for obtained symmetric keys.

In some instances, the second application 105 notifies the first application 110 whether the provided symmetric key has been imported successfully or not. The first application 110 can record the time stamp of such confirmation and use this time stamp to start evaluating subsequent heartbeat call from the second application 105. In some instances, the time stamp of such received confirmation can be defined as a start point of an evaluation period of evaluating subsequent heartbeats received from a receiver (e g., an entity that provides the identifier of the second application 105).

In some instances, after sharing the symmetric key with the second application 105, the first application 110 evaluates received heartbeat calls from the second application 105 and/or other applications that may present themselves as the second application by identifying with the application ID of the second application. Based on the evaluation of received heartbeat calls (e.g., calls after a time stamp when the second application 105 has confirmed successful importing of the symmetric key, where the calls are captured in a predefined period of time, or correspond to at least a threshold number of calls), the first application 110 determines whether or not to exchange (at 140) the secret information encrypted based on the symmetric key (as exchanged at 135).

In some instances, once the second application 105 receives the secret information, the second application 105 can use the secret information according to implemented logic and different application scenarios. For example, the received secret information may be user credential information of a user associated with the first application (e.g., user 105), and the user credentials can be used by a token generator 145 at the second application to generate a secure token that can be shared with the first application 110 and used for authorizing requests for resources from the first application 110.

In some instances, the second application 105 provides the decrypted secret information for a secure token generation for authorizing the user 105 to performed operations requested through the receiver second application 105.

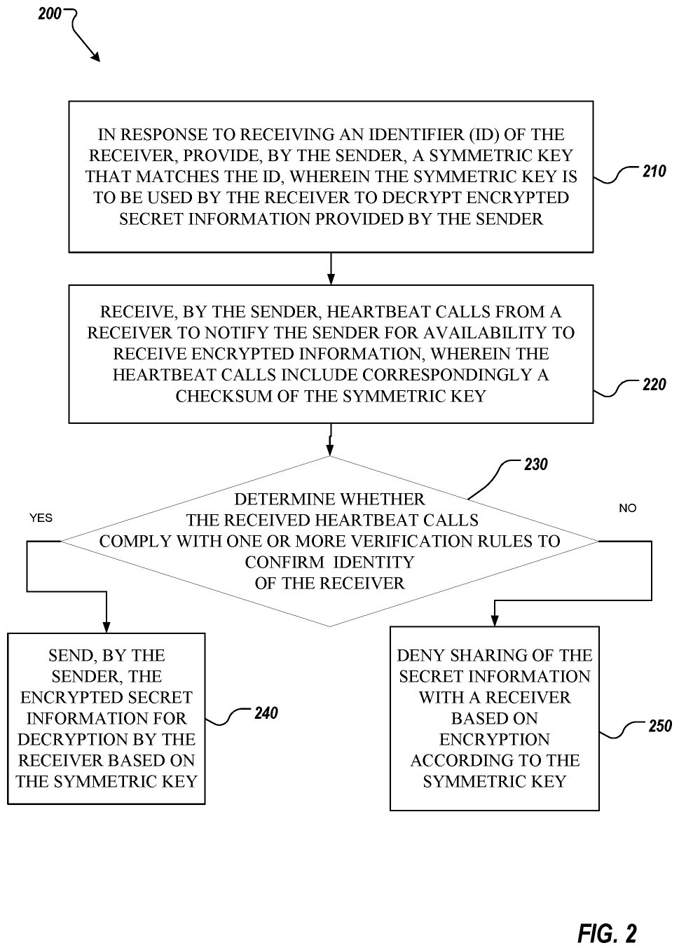

FIG. 2 is a flowchart of an example process 200 for sharing secret data in secure manner over an unsecured communication channel in accordance with some embodiments. The example process 200 can be executed at a computing environment including two applications that are a sender and a receiver. The two application are running in a computing environment substantially similar to the computing environment 100 of FIG. 1. The example process 200 can be executed in relation to receiving and sending applications as discussed throughout this disclosure and in particular at FIGS. 1, 3, and 4.

In some implementations, the sending application can be configured to send secret information to a receiver over an unsecure communication in a secure manner by verifying identity of a receiver based on exchanging a symmetric key. The sending application monitors and evaluates incoming calls that provide information for obtained data from receiver that claims to correspond to the receiver based on an application ID that is known to the sender but can be spoofed by a third-party in an attempt to steal confidential data.

At 210, a sender provides a symmetric key to a receiver. In some implementations, the sender is substantially similar to the first application 110 of FIG. 1, and the receiver is substantially similar to the second application 105. The sender provides the symmetric key in response to receiving an ID (e.g., secret ID) of the receiver. The sender provides a symmetric key that matches the ID provided with the request from the receiver. In some instances, the symmetric key can be used by the receiver to decrypt encrypted information (that is encrypted with the same symmetric key) provided by the sender. The information can be secret information.

At 220, the sender receives heartbeat calls from a receiver to notify the sender of availability to receive encrypted information. Each of the received heartbeat calls includes a checksum of the symmetric key. The sender uses the provided checksum of the symmetric key in heartbeat calls to determine whether the sender of the heartbeat is the receiver who obtained the shared symmetric key.

In some instances, multiple heartbeat calls are send from the receiver of the symmetric key in a period of time after receiving the symmetric key and before receiving encrypted information from the sender. In some instances, the sender may receive heartbeat calls from multiple entities that present themselves as the receiver based on the ID of the receiver. In those instances, the sender may be unable to uniquely identify a receiver that is the target receiver for the information sharing.

At 230, the sender determines whether the received heartbeat calls comply with one or more verification rules for confirming an identity of the receiver. In some implementations, the one or more verification rules include rules for identifying consistency in received heartbeat calls at the sender.

At 240, if the sender determines that the received heartbeat calls comply with the one or more verification rules, the sender sends the encrypted information for decryption by the receiver using the symmetric key. The sender sends the encrypted information to the receiver upon determination that the received heartbeat calls are received from a single receiver that has access to the symmetric key to decrypt the encrypted information.

At 250, if the sender determines that the received heartbeat calls do not comply with the one or more verification rules, the sender denies sharing of the information with the receiver based on encryption according to the exchanged symmetric key.

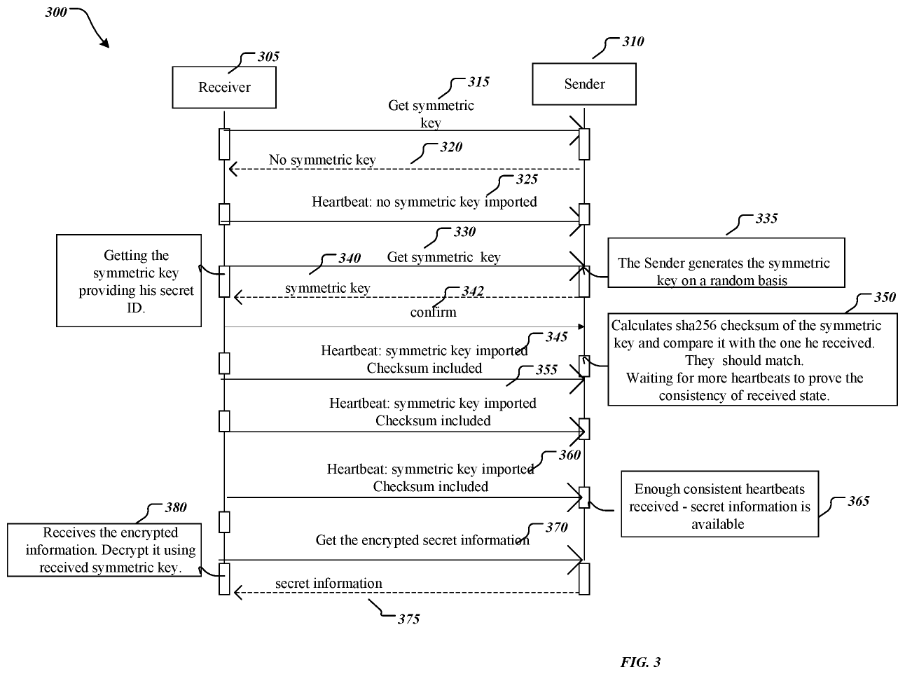

FIG. 3 is a schematic diagram 300 illustrating an example for exchanging a symmetric key that is used for subsequent encryption and decryption of exchanged information from a sender to a receiver application in accordance with some embodiments. The diagram illustrates a receiver 305 and a sender 310 that substantially correspond to the second application 105 and the first application 110 of FIG. 1, and to the receiver and sender as described in the disclosure of FIG. 2, and throughout the present disclosure.

The receiver 305 and the sender 310 can communicate to exchange data over an unsecured (unauthenticated) communication channel, where such channel can be securely used for exchanging sensitive data based on a symmetric key encryption and decryption in accordance with implementations of the present disclosure.

In some implementations, the sender 310 registers the receiver 305 as a known application based on an ID provided by the receiver 305 and stored by the sender 310. The sender 310 can execute an implemented scenario where the sender 310 wants to exchange information with the receiver 305 in the context of secure token generation.

At 315, the receiver 305 sends a request to the sender 310 to obtain a symmetric key. The symmetric key is used to secure exchange of data between the two entities. The sender 310 verifies the identity of the entity that claims to be the target receiver (i.e., 305).

At 320, the sender 310 notifies the receiver 305 that a symmetric key is not available. For example, the sender 310 can notify the receiver 305 that the symmetric key is not available while the symmetric key is generated and/or about to be designated to a particular receiver 305 for sharing particular secret data.

In some implementations, the receiver 305 is configured to send regular heartbeat calls to the sender 310. The receiver 305 can import information for the status of information that is obtained from the sender 310 so far. For example, the receiver 305 sends a heartbeat call 325 after a request for a symmetric key (315) where the symmetric key was not yet available and provided by the sender 310. The heartbeat call 325 includes a notification that the symmetric key is not yet imported at the receiver 305.

In some implementations, the sender 310 generates the symmetric key, for example, on a random basis to thwart any prediction attacks. The sender 310 can store the generated symmetric key at a storage or database (e.g., the symmetric key storage 120 of FIG. 1) to refer to the storage for subsequent checks of the use of the symmetric key and exchanges. In some instances, symmetric key has a short period of time to live, e.g., a predefined period comprising a number of hours or days (e.g. 48 hours). In those cases, upon expiry of the life-time of the symmetric key, the sender 310 can remove the symmetric key from the storage or database, or alternatively or additionally identify it as invalidated.

At regular intervals, the receiver 305 makes calls, such as the get request 315 and 330, to pull the symmetric key, by providing an ID in the request. In some other instances, the request to receive a symmetric key at 315 and/or 330 can be used to pull the symmetric key from the sender 310. In some instances, the symmetric key can be generated at 335) for the receiver 305 corresponding to the ID, for example, at a random moment in time. In some instances, the generation of the symmetric key is not based on a request for the symmetric key from the receiver 305.

In some embodiments, once the symmetric key is available at the sender 310 and the sender 310 has designated (e.g., by storing in a database) the symmetric key to the receiver 305, the sender 310 evaluates a received request to provide the symmetric key to the receiver 305. The sender 310 matches the provided ID with the request to the ID designated by the sender 310 for the generated symmetric key. In cases where there are multiple symmetric keys (e.g., the sender 310 has generated and stored multiple corresponding to different receivers), the sender 310 selects a symmetric key that matches the ID provided in the request.

In some implementations, in response to determining a symmetric key that is to be provided by the sender 310 to the receiver 305, the sender 310 updates a database that stores the symmetric key with a time stamp of the time of a confirmation received from the receiver 310 that the symmetric key was successfully imported. In some instances, the status of the symmetric key at the database can be updated to unavailable for pulling such that the symmetric key is not provided to other receivers identifying themselves with the ID. In some instances, no symmetric key is exchanged if the provided ID in the request from the receiver 305 matches an ID in the database that is mapped to a symmetric key from one or more symmetric keys currently maintained at the database

At 340, the sender 310 sends the determined symmetric key to the receiver 305, and the receiver 305 imports the symmetric key. For example, the receiver 305 imports the symmetric key in a key storage such as the symmetric key storage 115 of FIG. 1. The stored symmetric key at the receiver 305 can be used to decrypt encrypted information provided by the sender 310.

At 342, the receiver 305 sends a notification to the sender 310 whether the symmetric key was imported successfully or unsuccessfully. In some instances, the receiver 305 sends a confirmation for successfully importing the symmetric key. Based on the received confirmation, the sender 310 acknowledges the time stamp when the confirmation is received and uses this time stamp as a starting port for a validation period for subsequently received heartbeats from the receiver 305. The sender 310 can use the time stamp of the confirmation for the successful import rather than a time stamp when the symmetric key was sent as the starting period for performing evaluation of received heartbeat calls from a receiver to determine whether or not to share data encrypted with the symmetric key.

At 345, the receiver 305 calculates a hash value of the symmetric key that is imported. The hash value represents a string of letters and/or number that are calculated based on the symmetric key. In some instances, the sender 310 uses the hash value that is a checksum (e.g., SHA-256 checksum) to determine authenticity of received data, such as the symmetric key. For example, the checksum can be computed based on the SHA256 function that is a one-way function, which is practically infeasible to invert or reverse the computation. Thus, even if an imposter obtains the shared checksum from the receiver shares (e.g., by listening to the communication channel between the receiver 305 and the sender 310), the imposter would not be able to invert it to obtain the symmetric key.

In some instances, the receiver 305 and the sender 310 calculate hash values based on the symmetric keys they have access to, and the sender 310 uses the hash values to determine whether the receiver 305 possesses the same symmetric key as the one that is stored at the sender 310 and that has been shared with the receiver 305. The receiver 305 sends the calculated hash value of the symmetric key in its heartbeat calls to the sender 310 (e.g., at regular intervals). Thus, the receiver 305 notifies the sender 310 that he has successfully imported the symmetric key and that the sender 310 can proceed with providing the encrypted information

At 350, the sender 310 uses the received hash value (e.g., the checksum) to compare it with a computed hash value based on the symmetric key as stored at the sender 310. The sender 310 can confirms that the receiver 305 has successfully imported the symmetric key or can identify discrepancies in the information provided by the receiver 305 with the heartbeat and the information stored at the sender 310.

In some instances, when the sender 310 receives the heartbeat with the hash value, the sender 310 can use the same hash function (e.g., the one-way SHA function used by the receiver 305 for generating a checksum) to calculate a hash value based on the symmetric key stored at the database for the receiver 305. The sender 310 determined whether the calculated hash value and the received hash value matches. In some instances, if the two hash values do not match, the sender 310 invalidates the symmetric key he has sent and denies sharing of the information in encrypted form based on that symmetric key.

In some instances, the sender 310 determined that the two hash values—the one computed and the one received—match, and can further monitor heartbeats received from the receiver 305 to determine whether to provide the encrypted information.

At 360, the receiver 305 sends a subsequent (or more) heartbeat calls to the sender 310 providing consistent information of the imported symmetric key. The heartbeat calls can provide the hash value of the symmetric key as a proof for verification whether the receiver who send the heartbeat call 360 is the one who really obtained the symmetric key provided at 340.

At 365, the sender 310 determines whether the received heartbeat calls are consistent. In some instances, the heartbeat calls can include a series of heartbeat calls from the receiver 305 (identified by the ID) where each call provides information for importing the symmetric key that matches the one that was provided to the receiver 305 (at 340).

In some instances, the sender 310 evaluates received heartbeat calls from receivers according to one or more verification rules to determine whether the calls are originating from the same entity and to confirm the identity of the receiver 305 as the intended receiver for shared information.

In response to determining that the heartbeat calls comply with the one or more verification rules and the sender 310 confirms the identity of the receiver 305, the sender encrypts the secret information designed to the receiver 305 with the symmetric key mapped to the receiver 305. At 370, the receiver 305 requests to receive the encrypted information and the sender 310 sends the encrypted information (at 375).

At 380, the receiver 305 receives the encrypted information and decrypts it.

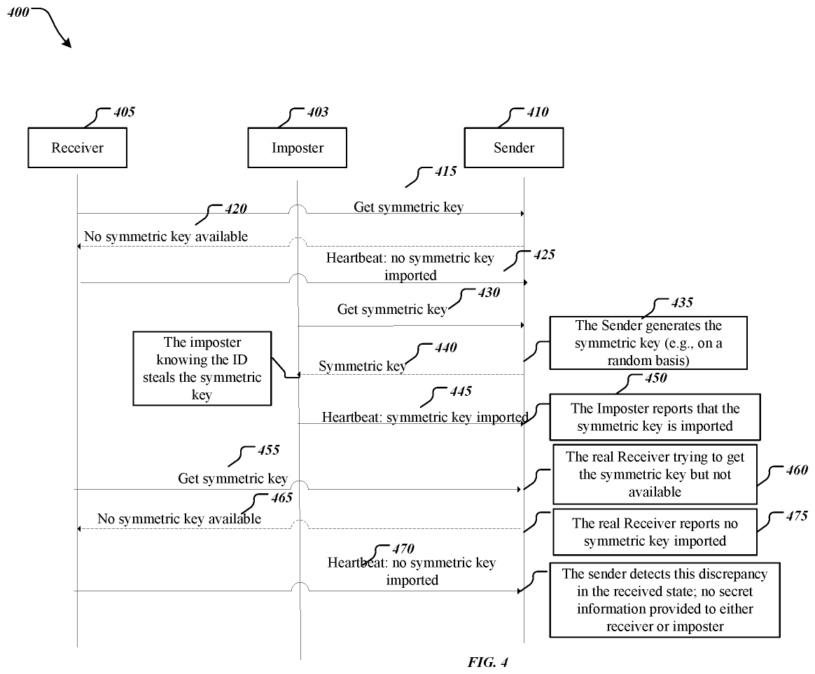

FIG. 4 is a schematic diagram 400 illustrating an example for denying sharing of secret information from a sender in response to determining inconsistency and failure to verify identity of a receiver as a target receiver for the secret information in accordance with some embodiments.

The diagram illustrates a receiver 405 and a sender 410 that substantially correspond to the second application 105 and the first application 110 of FIG. 1, and to the receiver and sender as described in the disclosure of FIG. 2, and further the receiver 305 and the sender 310 of FIG. 3.

The receiver 405 and the sender 410 can communicate to exchange data over an unsecured (unauthenticated) communication channel, in accordance with the disclosure of FIG. 3.

In some implementations, the sender 410 registers the receiver 405 as a known application based on an ID provided, and the receiver 405 sends a request 415 to the sender 410 to obtain a symmetric key.

At 420, the sender 410 notifies the receiver 305 that a symmetric key is not available. The sender 410 generates the symmetric and stores the generated symmetric key at a database (e.g., the symmetric key storage 120 of FIG. 1) to refer to the storage for subsequent checks of the use of the symmetric key and exchanges. The receiver 405 sends a heartbeat call 425 as part of a configured routine for sending heartbeat calls to the sender 410, for example, at regular intervals.

In some implementations, an imposter 403 obtains the ID of the receiver 405 that was used to register at the sender 410. The imposter 403 attempts to obtain the secret information from the sender 410 by pretending to be the receiver 405.

At 430, the imposter sends a request to obtain the symmetric key from the sender 410. Since the imposter requests the symmetric key based on the ID of the receiver 405, the sender 410 cannot reasonably identify whether this request 430 is genuine or not as it does not differentiate substantially from the request 415. At 435, the sender 410 generates a symmetric key (e.g., on random basis), and allocates it to the receiver 405 by mapping the ID of the receiver 405 to the symmetric key and storing it in a database. At 440, the sender 410 sends the symmetric key to the imposter 403. Thus, the imposter steals the symmetric key from the sender 410 by presenting himself as the receiver 405 with the ID of the receiver 405.

At 445, the imposter 403 sends heartbeat calls to the sender 410 in an attempt to mimic the behavior of the receiver 405 and to obtain the secret information from the sender 410. The heartbeat 445 includes a notification that the receiver as identified with the ID of the receiver 405 has obtained and imported the symmetric key. At 450, the sender 410 receives the heartbeat call sent by the imposter 403 and continues to listen for subsequent heartbeat calls to determine whether the heartbeat calls comply with one or more verification rules for confirming the identity of the entity sending the heartbeat calls.

In some instances, the one or more verification rules include a threshold number of subsequent heartbeat calls after a symmetric key has been provided that need to be obtained before a determination as to the identity of the receiver is made. In some instances, a verification rule can define a time-period for listening to heartbeats rather than a number of subsequent heartbeat calls.

In some instances, if a heartbeat call is send from the receiver (or imposter) close to the time point of providing the symmetric key to the receiver (or imposter), that heartbeat call might not include a notification of the symmetric key being imported, while it may be true that the symmetric key is provided and in the process of importing. Therefore, in some instances, obtaining a single heartbeat call may not be sufficient to make a determined. In some instances, the heartbeat call may include conflicting information with regard to the real exchange status of the symmetric key, but this might not be a deterministic step for denying the receiver access to the secret information. In some instances, the verification rules may include a rule that evaluates the time of the symmetric key when it was sent to the receiver (or imposter) and the time-period between that sending and a subsequent heartbeat call.

At 455, the receiver 405 sends a request to obtain the symmetric key. However, since the sender 410 has already sent the symmetric key at 440, at 460, the sender 410 determines that the symmetric key is unavailable for sharing. For example, the determination 460 can be made by evaluating the data stored for the symmetric key at the sender 410 that includes a status of the symmetric key and designed ID of the receiver. In other examples, the determination 460 can be made by other techniques of tracking exchange of data between the sender 410 and other entities, such as keeping a log file.

At 465, the sender 410 reports to the receiver 405 that the symmetric key is not available. The receiver 410 sends a heartbeat 470 that notifies that a symmetric key is not imported. Thus, the sender receives two subsequent heartbeats—heartbeat 445 and heartbeat 470—that are with contradicting information as to the status of the receiving of the symmetric key that was provided by the sender 410 at 440. Thus, at 475, the sender detects discrepancy in the received state of the symmetric key at the receiver. The sender 410 cannot differentiate between the two entities that send the two conflicting states with the heartbeats (445 and 470) to determine which one is the true owner of the identity of the receiver 405. Therefore, the sender denies sharing of the secret information with the receiver 405 and/or the imposter 403 based on encryption according to the symmetric key (as generated at 435).

In some implementations, the sender 410 implements one or more verification rules that require a threshold number of heartbeat calls (e.g., two or more heartbeat calls) to correspond to a predefine regime of notification at the sender 410 (e.g., within a predefined time interval such as every 15 minutes) to determine whether to share or deny sharing of secret information. The verification rules can define that the threshold number of calls include consistent information about the possession of symmetric key at the entity sending the heartbeat calls and that the provided hash value in the heartbeat calls matches a hash value computed based on the symmetric key stored at the sender 410. In some instances, the sender 410 implements verification rules that require at least two subsequent heartbeat calls at a consistent notification regime (corresponding to previously received heartbeat calls (e.g., received at regular time intervals)) in order to determines whether to send the secret information or to deny the sharing. For example, the sender 410 can determine to send the secret information based on determining that the at least two subsequent heartbeat calls include consistent content with regard to the status of the obtained symmetric key.

In some implementations, the imposter 403 sends the heartbeat call 445 prior to the get request 455 from the receiver 405, and if the imposter 403 also requests the secret information before the receiver 405 had sent the get request 455, the sender 410 evaluates the number of heartbeat calls received from the imposter 403 and the receiver 405 (425, 445) and evaluates whether those heartbeat calls include consistent information about the status of the symmetric key. In some instances, the imposter 403 sends a confirmation to the sender 410 to confirm that the symmetric key has been imported successfully. In those instances, the sender 410 records the time stamp of the received confirmation for the symmetric key and uses this time stamp as a start for an evaluation process for subsequently received heartbeat calls from a receiver entity that identifies itself with the identifier of the receiver. The sender 410 determines which is the entity that sends a heartbeat call by an identifier provided by the entity. While the imposter 403 is trying to impersonate the receiver 405, the receiver 405 also wants to obtain the secret information, and within a period of time (according to the configuration to send heartbeat calls at the receiver 405) the receiver sends the heartbeat call 470 that notifies that a symmetric key is not imported. In that case, the two heartbeat calls received at the sender 410—heartbeat 445 and 470—include contradicting information. The two heartbeat calls 445 and 470 include inconsistent information, since the first call (445) notifies successfully imported symmetric key and a subsequent heartbeat call 470 from the receiver 405 notifies that the symmetric key has not yet been imported. Even if the heartbeat call 445 provides a hash value of the symmetric key that is verified by the sender 410, the implemented one or more verification rules at the sender 410 require at least two subsequent heartbeat calls with consistent information. Thus, the sender 410 does not decide to share secret information with the imposter (or the receiver) based on those two heartbeat calls. In that instance, the sender 410 waits for further heartbeats to be evaluated based on the implemented one or more verification rules. In that case, the sender 410 can determine that the received heartbeats do not comply with the one or more verification rules since they do not include consistent information for the status of the symmetric key at an alleged receiver.

In some instances, the imposter 403 tries to impersonate the receiver 405 by sending heartbeat calls within shorter time period in an attempt to comply with the verification rules of the sender 410. However, the sender 410 includes implemented logic to evaluate the regime of receiving heartbeat calls from a given receiver based on the ID, and the sender 410 evaluates whether received heartbeat calls correspond to the notification regime (including the time period between successive heartbeat calls) corresponds to the expected regime. In some instances, the sender 410 evaluates all of the received heartbeat calls from the particular ID to determine whether all heartbeat calls at least substantially correspond to a regular-interval notification scheme. In some instances, the sender 410 is configured with information for the notification regime of the receiver 405 and verifies whether received heartbeat calls correspond to that information. For example, the regime can be a regular interval regime, or can be a defined as a series of notification instances configured according to a predefined rule (e.g., according to a time-progressions function (every 5, 5, 10, 10, 10, 20, 20, 20 minutes), a pre-fixed time points, other suitable function).

Embodiments of the subject matter described in this specification include computer systems, apparatus, and computer programs recorded on one or more computer storage devices, each configured to perform the actions of the described methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communications network. Examples of communications networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative.

Example 1 is a computer-implemented method for exchanging secret information over an unauthenticated communication channel between a sender and a receiver, the method comprising:
in response to receiving an identifier (ID) of the receiver, providing, by the sender, a symmetric key to the receiver that matches the ID, wherein the symmetric key is configured for use by the receiver to decrypt encrypted information provided by the sender;
receiving, by the sender, a plurality of heartbeat calls from a receiver to notify the sender of availability to receive encrypted information, wherein each call of the plurality of heartbeat calls includes a checksum of the symmetric key; and
in response to determining that the received plurality of heartbeat calls comply with one or more verification rules for confirming an identity of the receiver, sending, by the sender, the encrypted information for decryption by the receiver using the symmetric key.

Example 2 is the method of Example 1, wherein the one or more verification rules define rules for identifying consistency in received heartbeat calls at the sender.

Example 3 is the method any one of the previous Examples, wherein the encrypted information is encrypted secret information that is sent to the receiver upon determination that the plurality of heartbeat calls are received from a single receiver that has access to the symmetric key to decrypt the encrypted secret information.

Example 4 is the method of any one of the previous examples, comprising:
generating, by the sender, the symmetric key based on a random generation method, wherein the random generation method is configured to generate symmetric keys that uniquely correspond to different receivers.

Example 5 is the method of any one of the previous examples, comprising:
persisting, by the sender, a database storing the symmetric key and a receiver identifier.

Example 6 is the method of any one of the previous examples, wherein the symmetric key is provided to the sender in response to matching the received ID of the receiver with a receiver identifier associated with the symmetric key for the sender.

Example 7 is the method of any one of the previous examples, comprising:
receiving pulling requests from the receiver to obtain the symmetric key from the sender, wherein the pulling requests are executed at regular intervals and provide the ID as a unique identifier to prove the identity of the receiver.

Example 8 is the method of any one of the previous examples, comprising:
in response to providing the symmetric key to the receiver, updating, by the sender, a database storing the symmetric key with a current time of the providing of the symmetric key, and an unavailable status for providing the symmetric key to another receiver for decrypting shared secret information.

Example 9 is the method of any one of the previous examples, comprising:
in response to determining that one or more of the plurality of heartbeat calls do not comply with the one or more verification rules to confirm the identity of the receiver, denying sharing of the secret information with the receiver based on encryption according to the symmetric key.

Example 10 is the method of any one of the previous examples, wherein receiving the plurality of heartbeat calls comprises:
receiving, by the sender, a series of heartbeat calls that includes at least i) a notification that the symmetric key is imported at the receiver and ii) a request to obtain the symmetric key after the symmetric key has been provided to the receiver, and
wherein in response to evaluating the series of heartbeat calls received at the sender from the receiver, determining that the received heartbeat calls do not comply with the one or more verification rules for confirming the identity of the receiver based on identifying inconsistent subsequent heartbeat calls from the receiver in the series.

Example 11 is the method of any one of the previous examples, wherein the secret information is credential information of a user authorized with the sender, and wherein
in response to receiving the encrypted information by the receiver, decrypting, by the receiver, the encrypted information with the symmetric key, and
providing the decrypted secret information for a secure token generation for authorizing the user to performed operations requested through the receiver.

While this specification contains many specific implementation details, these should not be construed as limitations on the scope of any implementation or on the scope of what may be claimed, but rather as descriptions of features that may be specific to particular implementations of the disclosure. Certain features that are described in this specification in the context of separate implementations can also be implemented in combination or in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In certain implementations, multitasking and parallel processing can be advantageous.

What is claimed is:

1. A computer-implemented method for exchanging secret information over an unauthenticated communication channel between a sender and a receiver, the method comprising:
in response to receiving an identifier (ID) of the receiver, providing, by the sender, a symmetric key to the receiver that matches the ID, wherein the symmetric key is configured for use by the receiver to decrypt encrypted information provided by the sender;
receiving, by the sender, a plurality of heartbeat calls from a receiver to notify the sender of availability to receive encrypted information, wherein each call of the plurality of heartbeat calls includes a checksum of the symmetric key; and
in response to determining that the received plurality of heartbeat calls comply with one or more verification rules for confirming an identity of the receiver, sending, by the sender, the encrypted information for decryption by the receiver using the symmetric key.

2. The method of claim 1, wherein the one or more verification rules define rules for identifying consistency in received heartbeat calls at the sender.

3. The method of claim 1, wherein the encrypted information is encrypted secret information that is sent to the receiver upon determination that the plurality of heartbeat calls are received from a single receiver that has access to the symmetric key to decrypt the encrypted secret information.

4. The method of claim 1, comprising:
generating, by the sender, the symmetric key based on a random generation method, wherein the random generation method is configured to generate symmetric keys that uniquely correspond to different receivers.

5. The method of claim 1, comprising:
persisting, by the sender, a database storing the symmetric key and a receiver identifier.

6. The method of claim 1, wherein the symmetric key is provided to the sender in response to matching the received ID of the receiver with a receiver identifier associated with the symmetric key for the sender.

7. The method of claim 1, comprising:
receiving pulling requests from the receiver to obtain the symmetric key from the sender, wherein the pulling requests are executed at regular intervals and provide the ID as a unique identifier to prove the identity of the receiver.

8. The method of claim 1, comprising:
in response to providing the symmetric key to the receiver, updating, by the sender, a database storing the symmetric key with a current time of the providing of the symmetric key, and an unavailable status for providing the symmetric key to another receiver for decrypting shared secret information.

9. The method of claim 1, comprising:
in response to determining that one or more of the plurality of heartbeat calls do not comply with the one or more verification rules to confirm the identity of the receiver, denying sharing of the secret information with the receiver based on encryption according to the symmetric key.

10. The method of claim 1, wherein receiving the plurality of heartbeat calls comprises:
receiving, by the sender, a series of heartbeat calls that includes at least i) a notification that the symmetric key is imported at the receiver and ii) a request to obtain the symmetric key after the symmetric key has been provided to the receiver, and
wherein in response to evaluating the series of heartbeat calls received at the sender from the receiver, determining that the received heartbeat calls do not comply with the one or more verification rules for confirming the identity of the receiver based on identifying inconsistent subsequent heartbeat calls from the receiver in the series.

11. The method of claim 1, wherein the secret information is credential information of a user authorized with the sender, and wherein
in response to receiving the encrypted information by the receiver, decrypting, by the receiver, the encrypted information with the symmetric key, and
providing the decrypted secret information for a secure token generation for authorizing the user to performed operations requested through the receiver.

12. A non-transitory, computer-readable medium coupled to one or more processors and having instructions stored thereon which, when executed by the one or more processors, cause the one or more processors to perform operations, the operations comprising:
in response to receiving an identifier (ID) of the receiver, providing, by the sender, a symmetric key to the receiver that matches the ID, wherein the symmetric key is configured for use by the receiver to decrypt encrypted information provided by the sender;
receiving, by the sender, a plurality of heartbeat calls from a receiver to notify the sender of availability to receive encrypted information, wherein each call of the plurality of heartbeat calls includes a checksum of the symmetric key; and
in response to determining that the received plurality of heartbeat calls comply with one or more verification rules for confirming an identity of the receiver, sending, by the sender, the encrypted information for decryption by the receiver using the symmetric key.

13. The computer-readable medium of claim 12, wherein the one or more verification rules define rules for identifying consistency in received heartbeat calls at the sender.

14. The computer-readable medium of claim 12, wherein the encrypted information is encrypted secret information that is sent to the receiver upon determination that the plurality of heartbeat calls are received from a single receiver that has access to the symmetric key to decrypt the encrypted secret information.

15. The computer-readable medium of claim 12, wherein receiving the plurality of heartbeat calls comprises:
receiving, by the sender, a series of heartbeat calls that includes at least i) a notification that the symmetric key is imported at the receiver and ii) a request to obtain the symmetric key after the symmetric key has been provided to the receiver, and
wherein in response to evaluating the series of heartbeat calls received at the sender from the receiver, determining that the received heartbeat calls do not comply with the one or more verification rules for confirming the identity of the receiver based on identifying inconsistent subsequent heartbeat calls from the receiver in the series.

16. A system comprising
a computing device; and
a computer-readable storage device coupled to the computing device and having instructions stored thereon which, when executed by the computing device, cause the computing device to perform operations, the operations comprising:
in response to receiving an identifier (ID) of the receiver, providing, by the sender, a symmetric key to the receiver that matches the ID, wherein the symmetric key is configured for use by the receiver to decrypt encrypted information provided by the sender;
receiving, by the sender, a plurality of heartbeat calls from a receiver to notify the sender of availability to receive encrypted information, wherein each call of the plurality of heartbeat calls includes a checksum of the symmetric key; and
in response to determining that the received plurality of heartbeat calls comply with one or more verification rules for confirming an identity of the receiver, sending, by the sender, the encrypted information for decryption by the receiver using the symmetric key.

17. The system of claim 16, wherein the one or more verification rules define rules for identifying consistency in received heartbeat calls at the sender.

18. The system of claim 16, wherein the encrypted information is encrypted secret information that is sent to the receiver upon determination that the plurality of heartbeat calls are received from a single receiver that has access to the symmetric key to decrypt the encrypted secret information.

19. The system of claim 16, wherein the computer-readable storage device comprises instructions stored thereon which, when executed by the computing device, cause the computing device to perform operations comprising:
in response to providing the symmetric key to the receiver, updating, by the sender, a database storing the symmetric key with a current time of the providing of the symmetric key, and an unavailable status for providing the symmetric key to another receiver for decrypting shared secret information.

20. The computer-readable medium of claim 12, wherein receiving the plurality of heartbeat calls comprises:
receiving, by the sender, a series of heartbeat calls that includes at least i) a notification that the symmetric key is imported at the receiver and ii) a request to obtain the symmetric key after the symmetric key has been provided to the receiver, and
wherein in response to evaluating the series of heartbeat calls received at the sender from the receiver, determining that the received heartbeat calls do not comply with the one or more verification rules for confirming the identity of the receiver based on identifying inconsistent subsequent heartbeat calls from the receiver in the series.
